(19) United States
(12) Patent Application Publication
(10) Pub. No.: US 2023/0003861 A1
(43) Pub. Date: Jan. 5, 2023

(54) LIDAR WITH SEGMENTED PHOTODIODE

(71) Applicant: Seagate Technology LLC, Fremont, CA (US)

(72) Inventors: Eric James Dahlberg, Eden Prairie, MN (US); Daniel Joseph Klemme, Robbinsdale, MN (US)

(21) Appl. No.: 17/854,351

(22) Filed: Jun. 30, 2022

Related U.S. Application Data
(60) Provisional application No. 63/216,892, filed on Jun. 30, 2021.

(51) Int. Cl. G01S 7/497; G01S 7/481

(52) U.S. Cl. CPC G01S 7/4972; G01S 7/4817

(57) ABSTRACT

A light detection and ranging system can have an avalanche photodiode detector positioned between at least one pair of non-avalanche photodiode detectors with each detector connected to a photon controller. The photon controlled may selectively activate one or more detectors to determine an alignment of photons emitted by one or more emitters.

### SUMMARY

Light detection and ranging can be optimized, in various embodiments, by positioning an avalanche photodiode detector between at least one pair of non-avalanche photodiode detectors with each detector connected to a photon controller configured to selectively activate detectors to determine an alignment of photons emitted by one or more emitters.

### BRIEF DESCRIPTION OF THE DRAWINGS

FIG. 1 is a block representation of an example environment in which assorted embodiments can be practiced.

FIG. 2 plots operational information for an example detection system configured in accordance with some embodiments.

FIGS. 3A & 3B respectively depict portions of an example detection system arranged and operated in accordance with various embodiments.

FIG. 4 depicts portions of an example detection system constructed and employed in accordance with some embodiments.

FIG. 5 depicts a block representation of portions of an example detection system employed in accordance with assorted embodiments.

FIG. 6 depicts line representations of portions of an example detection system that may be utilized with in assorted embodiments.

### DETAILED DESCRIPTION

Various embodiments of the present disclosure are generally directed to optimization of an active light detection system.

Advancements in computing capabilities have corresponded with smaller physical form factors that allow intelligent systems to be implemented into a diverse variety of environments. Such intelligent systems can complement, or replace, manual operation, such as with the driving of a vehicle or flying a drone. The detection and ranging of stationary and/or moving objects with radio or sound waves can provide relatively accurate identification of size, shape, and distance. However, the use of radio waves (300 GHz-3 kHz) and/or sound waves (20 kHZ-200 kHz) can be significantly slower than light waves (430-750 Terahertz), which can limit the capability of object detection and ranging while moving.

The advent of light detection and ranging (LiDAR) systems employ light waves that propagate at the speed of light to identify the size, shape, location, and movement of objects with the aid of intelligent computing systems. The ability to utilize multiple light frequencies and/or beams concurrently allows LiDAR systems to provide robust volumes of information about objects in a multitude of environmental conditions, such as rain, snow, wind, and darkness. Yet, current LiDAR systems can suffer from inefficiencies and inaccuracies during operation that jeopardize object identification as well as the execution of actions in response to gathered object information. Hence, embodiments are directed to structural and functional optimization of light detection and ranging systems to provide increased reliability, accuracy, safety, and efficiency for object information gathering.

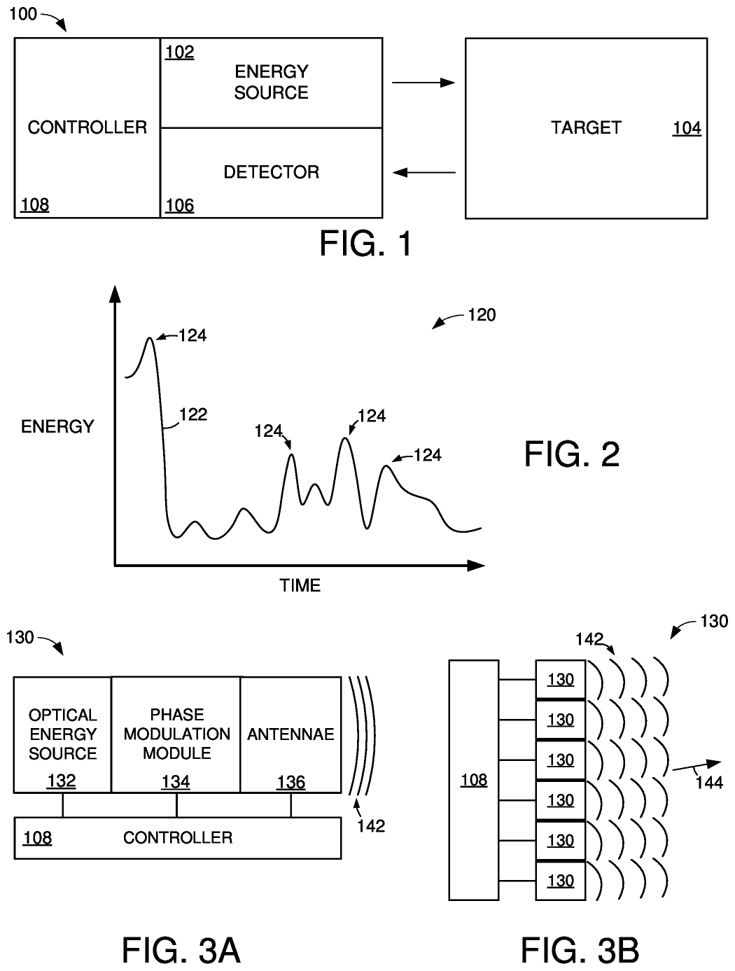

FIG. 1 depicts a block representation of portions of an example object detection environment 100 in which assorted embodiments can be practiced. One or more energy sources 102, such as a laser or other optical emitter, can produce photons that travel at the speed of light towards at least one target 104 object. The photons bounce off the target 104 and are received by one or more detectors 106. An intelligent controller 108, such as a microprocessor or other programmable circuitry, can translate the detection of returned photons into information about the target 104, such as size and shape.

The use of one or more energy sources 102 can emit photons over time that allow the controller 108 to track an object and identify the target's distance, speed, velocity, and direction. FIG. 2 plots operational information for an example light detection and ranging system 120 that can be utilized in the environment 100 of FIG. 1. Solid line 122 conveys the volume of photons received by a detector over time. The greater the intensity of returned photons (Y axis) can be interpreted by a system controller as surfaces and distances that that can be translated into at least object size and shape.

It is contemplated that a system controller can interpret some, or all, of the collected photon information from line 122 to determine information about an object. For instance, the peaks 124 of photon intensity can be identified and used alone as part of a discrete object detection and ranging protocol. A controller, in other embodiments, can utilize the entirety of photon information from line 122 as part of a full waveform object detection and ranging protocol. Regardless of how collected photon information is processed by a controller, the information can serve to locate and identify objects and surfaces in space in front of the light energy source.

FIGS. 3A & 3B respectively depict portions of an example light detection assembly 130 that can be utilized in a light detection and ranging system 140 in accordance with various embodiments. In the block representation of FIG. 3A, the light detection assembly 130 consists of an optical energy source 132 coupled to a phase modulation module 134 and an antennae 136 to form a solid-state light emitter and receiver. Operation of the phase modulation module 134 can direct beams of optical energy in selected directions relative to the antennae 136, which allows the single assembly 130 to stream one or more light energy beams in different directions over time.

FIG. 3B conveys an example optical phase array (OPA) system 140 that employs multiple light detection assemblies 130 to concurrently emit separate optical energy beams 142 to collect information about any downrange targets 104. It is contemplated that the entire system 140 is physically present on a single system on chip (SOC), such as a silicon substrate. The collective assemblies 130 can be connected to one or more controllers 108 that direct operation of the light energy emission and target identification in response to detected return photons. The controller 108, for example, can direct the steering of light energy beams 142 to a particular direction 144, such as a direction that is non-normal to the antennae 138, like 45°.

The use of the solid-state OPA system 140 can provide a relatively small physical form factor and fast operation, but can be plagued by interference and complex processing that jeopardizes accurate target 104 detection. For instance, return photons from different beams 142 may cancel, or alter, one another and result in an inaccurate target detection. Another non-limiting issue with the OPA system 140 stems from the speed at which different beam 142 directions can be executed, which can restrict the practical field of view of an assembly 130 and system 140.

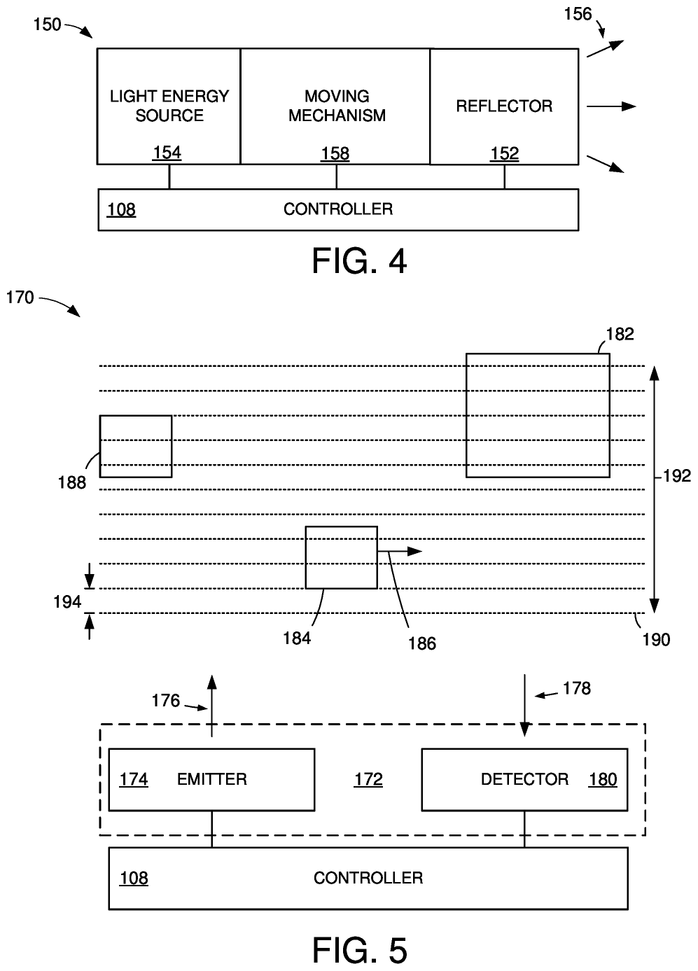

FIG. 4 depicts a block representation of a mechanical light detection and ranging system 150 that can be utilized in assorted embodiments. In contrast to the solid-state OPA system 140 in which all components are physically stationary, the mechanical system 150 employs a moving reflector 152 that distributes light energy from a source 154 downrange towards one or more targets 104. While not limiting or required, the reflector 152 can be a single plane mirror, prism, lens, or polygon with reflecting surfaces. Controlled movement of the reflector 152 and light energy source 154, as directed by the controller 108, can produce a continuous, or sporadic, emission of light beams 156 downrange.

Although the mechanical system 150 can provide relatively fast distribution of light beams 156 in different directions, the mechanism to physically move the reflector 152 can be relatively bulky and larger than the solid-state OPA system 140. The physical reflection of light energy off the reflector 152 also requires a clean environment to operate properly, which restricts the range of conditions and uses for the mechanical system 150. The mechanical system 150 further requires precise operation of the reflector 152 moving mechanism 158, which may be a motor, solenoid, or articulating material, like piezoelectric laminations.

FIG. 5 depicts a block representation of an example detection system 170 that is configured and operated in accordance with various embodiments. A light detection and ranging assembly 172 can be intelligently utilized by a controller 108 to detect at least the presence of known and unknown targets downrange. As shown, the assembly 172 employs one or more emitters 174 of light energy in the form of outward beams 176 that bounce off downrange targets and surfaces to create return photons 178 that are sensed by one or more assembly detectors 180. It is noted that the assembly 172 can be physically configured as either a solid-state OPA or mechanical system to generate light energy beams 172 capable of being detected with the return photons 178.

Through the return photons 178, the controller 108 can identify assorted objects positioned downrange from the assembly 172. The non-limiting embodiment of FIG. 5 illustrates how a first target 182 can be identified for size, shape, and stationary arrangement while a second target 184 is identified for size, shape, and moving direction, as conveyed by solid arrow 186. The controller 108 may further identify at least the size and shape of a third target 188 without determining if the target 188 is moving.

While identifying targets 182/184/188 can be carried out through the accumulation of return photon 178 information, such as intensity and time since emission, it is contemplated that the emitter(s) 174 employed in the assembly 172 stream light energy beams 176 in a single plane, which corresponds with a planar identification of reflected target surfaces, as identified by segmented lines 190. By utilizing different emitters 174 oriented to different downrange planes, or by moving a single emitter 174 to different downrange planes, the controller 108 can compile information about a selected range 192 of the assembly's field of view. That is, the controller 108 can translate a number of different planar return photons 178 into an image of what targets, objects, and reflecting surfaces are downrange, within the selected field of view 192, by accumulating and correlating return photon 178 information.

The light detection and ranging assembly 172 may be configured to emit light beams 176 in any orientation, such as in polygon regions, circular regions, or random vectors, but various embodiments utilize either vertically or horizontally single planes of beam 176 dispersion to identify downrange targets 182/184/188. The collection and processing of return photons 178 into an identification of downrange targets can take time, particularly the more planes 190 of return photons 178 are utilized. To save time associated with moving emitters 174, detecting large volumes of return photons 178, and processing photons 178 into downrange targets 182/184/188, the controller 108 can select a planar resolution 194, characterized as the separation between adjacent planes 190 of light beams 176.

In other words, the controller 108 can execute a particular downrange resolution 194 for separate emitted beam 176 patterns to balance the time associated with collecting return photons 178 and the density of information about a downrange target 182/184/188. As a comparison, tighter resolution 194 provides more target information, which can aid in the identification of at least the size, shape, and movement of a target, but bigger resolution 194 (larger distance between planes) can be conducted more quickly. Hence, assorted embodiments are directed to selecting an optimal light beam 176 emission resolution to balance between accuracy and latency of downrange target detection.

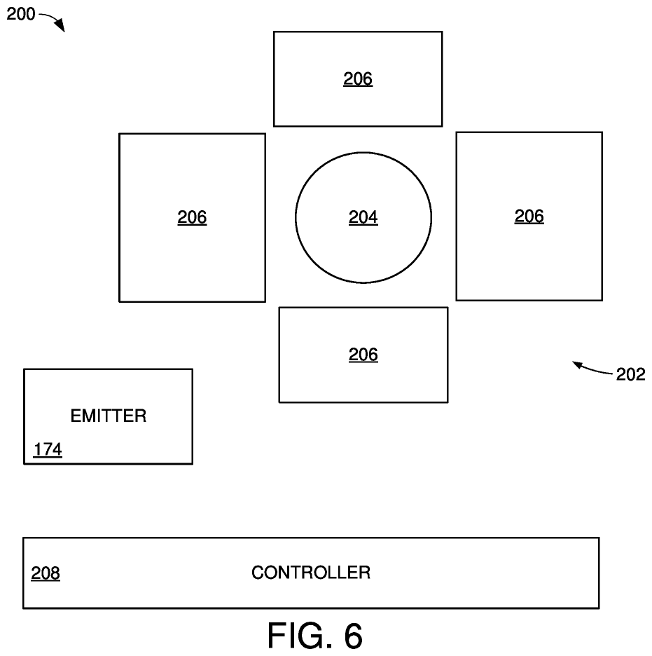

FIG. 6 depicts portions of an example light detection and ranging system 200 that can be employed in accordance with various embodiments. The system 200 can employ any number of light detectors 202 arranged to provide an operable field of view for light/photon reception. In the non-limiting example system 200 of FIG. 6, an avalanche photodiode detector 204 is separated from, but surrounded by, multiple non-avalanche photodiode detectors 206. A detector controller 208 can selectively activate different detectors 204/206 to determine alignment and functional efficiency of at least the avalanche detector 204.

It is contemplated that the non-avalanche detectors 206 may be activated in a diagnostic mode set by the controller 208 to determine the accuracy of photon reception, such as the correct photon origin location and/or intensity. As a result of concurrent, or sequential, detector 204/206 operation, photon beam alignment can be measured in real-time, which can then in turn be used to align the optics of the system 200 precisely and in an automated fashion.

The controller 108, in some embodiments, generates one or more strategies to proactively prescribe actions that mitigate, prevent, or eliminate unwanted system 200 operation. For instance, the controller 108 can prescribe alterations in operation for portions of the system 200 to control electrical power consumption, enhance reliability of readings, and/or heighten performance. As a non-limiting example, a power strategy can be generated by the controller 108 at any time and implemented upon an operational trigger, such as a detected, predicted, or selected emphasis on power consumption, to change one or more system 200 conditions to control power consumption. A power strategy may activate a detector 204/206 with lower power consumption to save power, even if the detector 204/206 has a lower accuracy, speed, or resolution. As such, a power strategy can prescribe activating, deactivating, or otherwise altering detector operation to control power consumption, even if such deviations degrade overall system 200 performance.

It is contemplated that the controller 108 can generate and execute a reliability strategy that proactively prescribes actions to provide maximum available consistency and accuracy in detecting and identifying downrange targets 104. For example, extra detectors 204/206 can be activated and operated to provide redundant readings of downrange targets 104 with similar, or dissimilar, light energy characteristics, such as wavelength, pulse width, or direction. Such operational deviations, in other embodiments, can be conducted as part of a preexisting performance strategy generated by the controller 108 to utilize one or more detectors 204/206 in a manner that optimizes at least one performance metric, such as speed of detection, largest field of view, or tightest resolution. The ability to execute predetermined operational deviations to emphasize a selected theme, such as performance, reliability, or power consumption, allows the controller 108 to intelligently utilize the multiple detectors 204/206 to provide optimal operation over time.

It is to be understood that even though numerous characteristics of various embodiments of the present disclosure have been set forth in the foregoing description, together with details of the structure and function of various embodiments, this detailed description is illustrative only, and changes may be made in detail, especially in matters of structure and arrangements of parts within the principles of the present technology to the full extent indicated by the broad general meaning of the terms in which the appended claims are expressed. For example, the particular elements may vary depending on the particular application without departing from the spirit and scope of the present disclosure.

What is claimed is:

1. An apparatus comprising a first photodiode detector positioned between at least one pair of non-avalanche photodiode detectors, each detector connected to a controller configured to activate at least one detector to sense a target positioned downrange from the first photodiode detector.

2. The apparatus of claim 1, wherein the first photodiode detector is an avalanche detector.

3. The apparatus of claim 1, wherein the first photodiode is positioned between two pair of non-avalanche photodiode detectors.

4. The apparatus of claim 1, wherein the first photodiode detector has a different size than the at least one pair of non-avalanche photodiode detectors.

5. The apparatus of claim 1, wherein the at least one pair of non-avalanche detectors are positioned on opposite sides of the first photodiode detector.

6. The apparatus of claim 1, wherein an emitter is connected to the controller and sends light beams downrange, as directed by the controller.

7. A method comprising:
positioning a first photodiode detector between at least one pair of non-avalanche photodiode detectors, each detector connected to a controller;
sending light beams downrange from an emitter connected to the controller; and
sensing a target positioned downrange of the first photodiode detector with at least one detector.

8. The method of claim 7, wherein the controller concurrently activates the first photodiode detector and the at least one pair of avalanche photodiode detectors to sense the target.

9. The method of claim 7, wherein the controller activates only the first photodiode detector to sense the target.

10. The method of claim 7, wherein the controller selects which detector to activate to sense the target in accordance with a predetermined power strategy directed to conserve power consumption.

11. The method of claim 7, wherein the controller selects which detector to activate to sense the target in accordance with a predetermined performance strategy directed to increase a speed of target sensing.

12. The method of claim 7, wherein the controller selects which detector to activate to sense the target in accordance with a predetermined reliability strategy directed to increase accuracy of target sensing.

13. A method comprising:
positioning a first photodiode detector between at least one pair of non-avalanche photodiode detectors, each detector connected to a controller;
sending light beams downrange from an emitter connected to the controller;
conducting, with the controller, a diagnostic mode with at least the first photodiode detector; and
sensing a target positioned downrange of the first photodiode detector with at least one detector.

14. The method of claim 13, wherein the diagnostic mode measures light beam alignment in real-time.

15. The method of claim 13, wherein the controller corrects photon origin location in response to the diagnostic mode.

16. The method of claim 13, wherein the controller corrects photon intensity in response to the diagnostic mode.

17. The method of claim 13, wherein the controller adjusts at least one detector to correct a misalignment in response to the diagnostic mode.

18. The method of claim 17, wherein the adjustment is conducted while sensing at least one target positioned downrange of the first photodiode detector.

19. The method of claim 13, wherein the first photodiode detector has a different light detecting characteristic that each of the at least one pair of non-avalanche photodiode detectors.

20. The method of claim 13, wherein the controller selectively activates detectors to determine an alignment of photons emitted by one or more emitters.
